(19) United States
(12) Patent Application Publication
(10) Pub. No.: US 2010/0128786 A1
(43) Pub. Date: May 27, 2010

(54) METHOD AND APPARATUS FOR ENCODING VIDEO DATA, METHOD AND APPARATUS FOR DECODING ENCODED VIDEO DATA AND ENCODED VIDEO SIGNAL

(76) Inventors: Yong Ying Gao, Beijing (CN); Yu Wen Wu, Beijing (CN); Ingo Tobias Doser, Villingen-Schwenningen (DE)

Correspondence Address: Robert D. Shedd, Patent Operations;THOMSON Licensing LLC, P.O. Box 5312, Princeton, NJ, 08543-5312, US

(21) Appl. No.: 12/450,928

(22) PCT Filed: Apr. 9, 2008
(86) PCT No.: PCT/EP2008/054307

§ 371 Date: Oct. 19, 2009

Related U.S. Application Data
(60) Provisional application No. 60/925,788, filed on Apr. 23, 2007.
(60) Provisional application No. 60/925,801, filed on Apr. 23, 2007.

(51) Int. Cl. H04N 7/32

(52) U.S. Cl. 375/240.13; 375/240.12; 375/E07.243

(57) ABSTRACT

For two or more versions of a video with different spatial, temporal or SNR resolution, scalability can be achieved by generating a base layer and an enhancement layer. When a version of a video is available that has higher color bit depth than can be displayed, a common solution is tone mapping. A more efficient compression method is proposed for the case where the two or more versions with different color bit depth use different color encoding. The present invention is based on joint inter-layer prediction among the available color channels. Thus, color bit depth scalability can also be used where the two or more versions with different color bit depth use different color encoding. In this case the inter-layer prediction is a joint prediction based on all color components. Prediction may also include color space conversion and gamma correction.

### FIELD OF THE INVENTION

This invention relates to digital video coding. More particular, the invention relates to a method and an apparatus for encoding video data, a method and an apparatus for decoding encoded video data and a correspondingly encoded video signal.

### BACKGROUND

In recent years, digital images/videos with bit depth higher than eight are more and more desirable in many application fields, such as medical image processing, digital cinema workflows in production and postproduction, and home theatre related applications. The state-of-the-art image/video coding technologies are also pushing ahead high bit depth coding. JVT standardized the high bit depth encoding in H.264 Fidelity Range Extensions (FRExt) supporting bit depth up to 14-bit and chroma sampling up to 4:4:4. On the other side, the Motion JPEG2000 (Part 3) supports up to 32 bits per component.

Color Bit depth scalability is potentially useful considering the fact that in a long period of time in the future, conventional 8-bit and high bit digital imaging systems will simultaneously exist in marketplaces. There are several ways to handle the coexistence of an 8-bit video and a high bit video. The first solution is to give only a high bit coded bit-stream and to enable tone mapping methods to give 8-bit representation for standard 8-bit display devices. The second solution is to give a simulcast bit-stream that contains an 8-bit coded bit-stream. It is the decoder's preference to choose which bit-stream to decode. It means, e.g, a stronger decoder with support of AVC High 10 Profile can decode and output a 10-bit video while a normal decoder can just output an 8-bit video. The first solution typically makes it impossible to be compliant with an H.264/AVC 8-bit decoder. The second solution is compliant to all the current standards but it requires more overhead. However, a good trade-off between the bit reduction and backward standard compatibility can be a scalable solution. SVC, also known as a scalable extension of H.264/AVC, is considering support of bit depth scalability.

There has not been much study on the approach for color bit depth scalability. Unlike spatial scalability which can be done using spatial upsampling between different resolutions, it was once challenged that it is likely that the additional information from the reconstructed low bit picture to the original high bit picture is difficult to encode, e.g., for 8-bit to 10-bit scalability, because of the introduced quantization error while encoding the 8-bit picture, the additional information can be up to 10-bit also. The inter-layer bit depth prediction is not similar to FGS either, which utilizes bit-plane scanning in transform domain.

Further, different possibilities of color encoding are known that use different types of color space, chromaticity coordinates and gamma correction, e.g. RGB, YCrCb, HSV, XYZ. Various conversion algorithms exist.

When a version of a video is available that has higher color bit depth than can be displayed, a common solution is tone mapping, wherein a high dynamic range is reduced to a lower color bit depth while contrast is preserved. When two or more versions of a video with different spatial, temporal or SNR resolution are available, scalability can be achieved by generating a base layer (BL) and an enhancement layer (EL) that is to be combined with the BL.

However, it is a problem inherent to the tone mapping method that more data than necessary are transmitted. A more efficient compression method is needed for the case where the two or more versions with different color bit depth use different color encoding.

### SUMMARY OF THE INVENTION

The present invention is based on the recognition of the fact that it is often advantageous in bit-depth scalable video coding to perform joint inter-layer prediction among the available color channels. Thus, according to the invention, color bit depth scalability can also be used where the two or more versions with different color bit depth use different color encoding. In this case the inter-layer prediction is a joint prediction based on all color components. Prediction may also include color space conversion and gamma correction.

According to one aspect of the invention, a method for encoding video data comprising base layer data and enhancement layer data, wherein the base layer and enhancement layer data comprise a plurality of color channels, such as Y, Cr, Cb or R, G, B, and wherein base layer and enhancement layer data have different bit depth, comprising steps of encoding the base layer data, predicting the enhancement layer data from the base layer data separately for the color channels, and encoding the enhancement layer data separately for the color channels, based on said predicted enhancement layer data, wherein in at least one mode each enhancement layer color channel is predicted jointly from all available base layer color channels, the method further comprising for at least one of the enhancement layer color channels the further steps of

generating residual data being the difference between original enhancement layer color channel and predicted color channel data, encoding the original enhancement layer color channel data, encoding the residual data, selecting for the at least one enhancement layer color channel either the encoded original enhancement layer color channel data, the residual data or the encoded residual data, wherein the selection is independent from the selection of other enhancement layer color channels, and providing as enhancement layer output data the selected enhancement layer color channel data and an indication of the selected encoding mode referring to said enhancement layer color channel.

According to another aspect of the invention, a method for decoding encoded video data having BL and EL data comprises the steps of

extracting from the encoded video data the BL data and the EL data, wherein both the BL data and the EL comprise separate data for a plurality of color channels, extracting for at least a first color channel of the enhancement layer an indication indicating an encoding mode, decoding the base layer data of the plurality of color channels, predicting the EL data based on the decoded base layer data, wherein in at least one mode each EL color channel is predicted jointly from all available BL color channels, decoding the EL data of the plurality of color channels, wherein residuals are obtained and wherein for at least said first color channel said indication is used for a decoding according to the indicated encoding mode, and reconstructing the EL data of the plurality of color channels based on the predicted EL data and said residuals.

According to yet another aspect of the invention, an apparatus for encoding video data comprising base layer and enhancement layer, wherein the base layer and enhancement layer data comprise a plurality of color channels and wherein base layer and enhancement layer have different bit depth, comprises means for encoding the base layer, means for predicting the enhancement layer from the base layer separately for the color channels, and means for encoding the enhancement layer separately for the color channels (e.g. R, G, B), based on said predicted enhancement layer, wherein in at least one mode each enhancement layer color channel is predicted jointly from all available base layer color channels, and the apparatus further comprises for at least one of the enhancement layer color channels means for generating a residual being the difference between original enhancement layer color channel and predicted color channel image, means for encoding the original enhancement layer color channel image, means for encoding the residual, means for selecting for the at least one enhancement layer color channel either the encoded original enhancement layer color channel image, the residual or the encoded residual, wherein the selection is independent from the selection of other enhancement layer color channels, and means for providing as enhancement layer output data the selected enhancement layer color channel data and an indication of the selected encoding mode referring to said enhancement layer color channel.

According to a further aspect of the invention, an apparatus for decoding encoded video data having base layer and enhancement layer data, comprises means for extracting from the encoded video data the base layer data and the enhancement layer data, wherein both the base layer data and the enhancement layer comprise separate data for a plurality of color channels, means for extracting for at least a first color channel of the enhancement layer an indication indicating an encoding mode, means for decoding the base layer data of the plurality of color channels, means for predicting the enhancement layer data based on the decoded base layer data, wherein in at least one mode each enhancement layer color channel is predicted jointly from all available base layer color channels, means for decoding the enhancement layer data of the plurality of color channels, wherein residuals are obtained and wherein for at least said first color channel said indication is used for a decoding according to the indicated encoding mode, and means for reconstructing the enhancement layer data of the plurality of color channels based on the predicted enhancement layer data and said residuals.

According to another aspect, an encoded video signal comprising base layer and enhancement layer data, wherein the base layer data comprise a plurality of color channels of a first color encoding and the enhancement layer data comprise a plurality of color channels of a different second color encoding, the base layer data and enhancement layer data having different color bit depth, and wherein the signal further comprises an encoding mode indication indicating for at least a first of the enhancement layer color channels whether it comprises either encoded residual data or, otherwise, encoded macroblock data.

It is a particular advantage of the presented coding solution that it is compliant to the H.264/AVC standard and compatible to all kinds of scalability that are currently supported in H.264/AVC scalable extension (SVC).

At least one implementation presents an H.264/AVC compliant color bit depth scalable coding solution, where the low bit (usually 8-bit) and the high bit (e.g. 10, 12, or 14-bit) sequences are encoded as base layer and enhancement layer(s), respectively. In one embodiment of the disclosed solution, inter-layer prediction between the low bit BL and the high bit EL is done in MacroBlock (MB) level to take advantage of the redundancy between the low-bit and high-bit representations of the same video. Moreover, the inter-layer color bit depth prediction of each color channel, e.g. Y, Cb, or Cr is not independent. Instead, it is conducted in a joint way such that the predicted version of each channel of the enhancement layer MB is determined by all (usually three) of the color channels of the reconstructed collocated base layer MB through the joint inter-layer color bit depth prediction.

Advantageous embodiments of the invention are disclosed in the dependent claims, the following description and the figures.

### BRIEF DESCRIPTION OF THE DRAWINGS

Exemplary embodiments of the invention are described with reference to the accompanying drawings, which show in

FIG. 1 a framework of color bit depth scalable coding;

FIG. 2 joint interlayer prediction in intra-coding;

FIG. 3 joint interlayer prediction in inter-coding; and

FIG. 4 adaptive inter-layer color bit depth prediction in inter-coding.

### DETAILED DESCRIPTION OF THE INVENTION

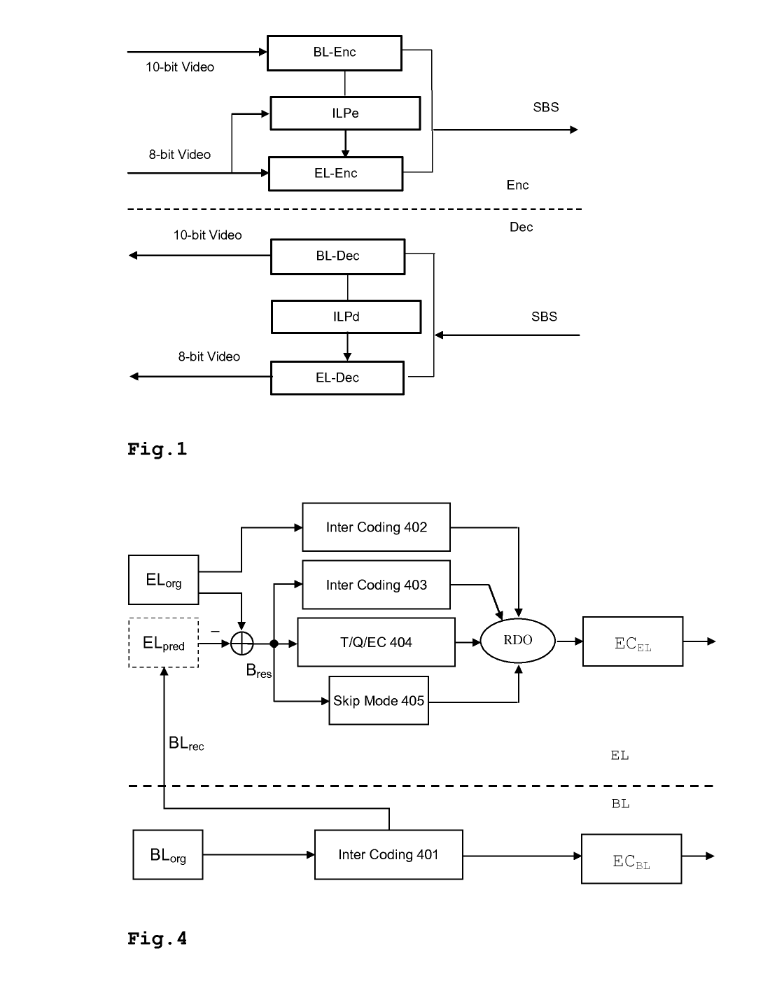

Without loss of generality, we assume that there are two layers of color bit depth scalability: one is 8-bit video sequence while the other one is 10-bit video sequence. The framework of the presented color bit depth scalable coding is shown in FIG. 1 for at least one implementation.

The scalable encoder Enc generates a bit depth scalable bitstream SBS, with the BL and the EL coded pictures multiplexed. The scalable decoder Dec can generate either an 8-bit video by decoding only the BL bitstream or generates a 10-bit video by decoding the whole scalable bitstream SBS. Providing multiple versions of different bit depth for the same visual content to different clients, device adaptation is reached by the proposed color bit depth scalable coding.

It shall be stressed that the two input sequences, 8-bit and 10-bit video sequences, may differ not only in bit depth. Hence, the inter-layer prediction may contain, for example:

1) adjustment for different gamma correction and different chromaticity coordinates, e.g., RGB color space (Rec. BT. 601) to RGB color space (Rec. BT. 709) conversion, RGB color space (Rec. BT. 601) to a device specified RGB color space conversion.

2) color space conversion (including adjustment for different gamma correction), e.g., XYZ color space to sRGB color space conversion, YCbCr color space (Rec. BT. 709) to RGB color space (Rec. BT. 709) conversion, YCbCr color space (Rec. BT. 601) to YCbCr color space (Rec. BT. 709) conversion.

3) chroma format conversion, e.g., YCbCr 4:2:0 to YCbCr 4:2:2, YCbCr 4:2:0 to YCbCr 4:4:4,

4) color correction, and

5) combination of the above items.

Cases 1), 2) and 3) may involve non-linear transformation, while in case 4) the relationship between the two considered sequences can be as complicated as look-up table (LUT). Further, case 2) may also involve the processing across different color channels. For instance, YCbCr color space (Rec. BT. 709) to RGB color space (Rec. BT. 709) conversion is mathematically modeled as matrix manipulation such that for each pixel, the value of R (G, or B) is calculated by a linear combination of the value of Y, Cb, and Cr. At least one implementation presents a joint inter-layer prediction that contains processes across different color channels, which can be done in either picture level or MB level.

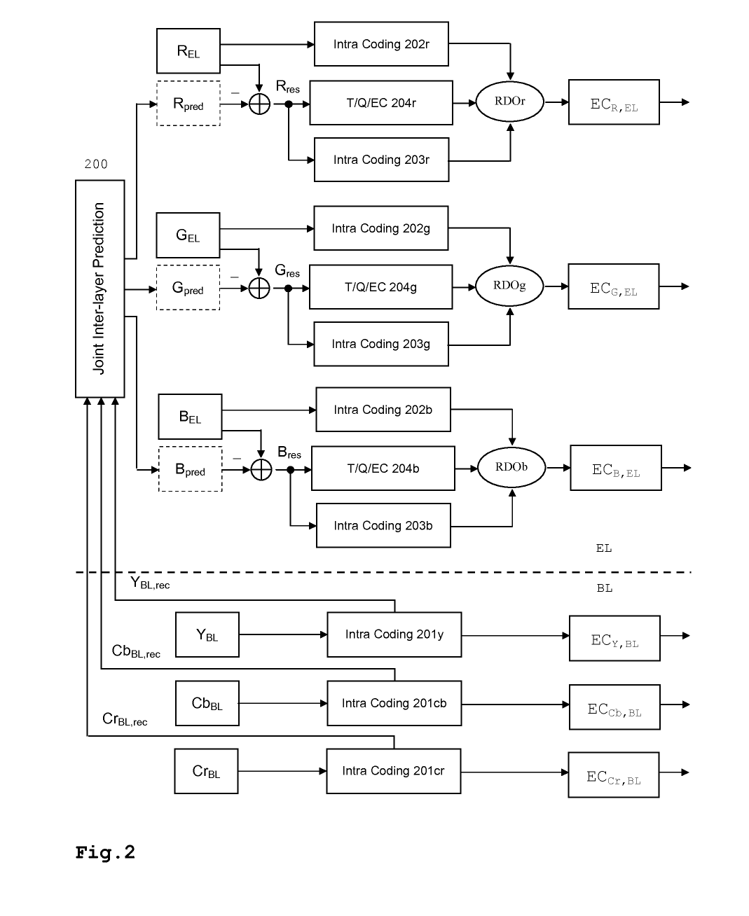

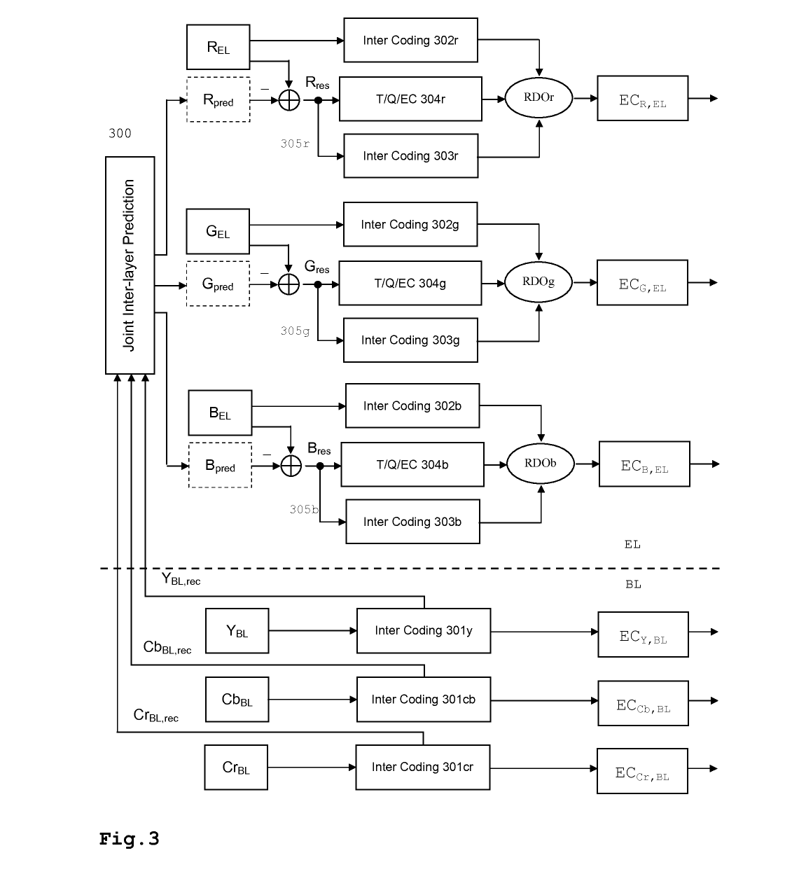

In the following, encoding/decoding methods are given for enabling joint inter-layer color bit depth prediction. In this part details of various implementations are presented. Such implementations may be discussed in other sections as well. At least one implementation provides the technical solution to AVC compliant joint inter-layer prediction for enabling color bit depth scalability. The corresponding diagrams of color bit depth scalable encoder in Intra- and Inter-coding that contains MB level inter-layer color bit depth prediction are shown in FIG. 2 and FIG. 3. Without loss of generality, we assume the inter-layer color bit depth prediction contains YCbCr color space (Rec. BT. 709) to RGB color space (Rec. BT. 709) conversion. The decoding process is an inverse procedure of the encoding process in both Intra- and Inter-coding.

Regarding FIG. 2 and FIG. 3, it is to be noted that the three rate-distortion optimization blocks (RDO) RDOr,RDOg,RDOb are independent from each other. That is, for each of the color channels it can be individually decided whether the enhancement layer is directly intra/inter coded without prediction, or otherwise a prediction is performed resulting in a residual and the residual is either directly intra/inter coded, or transformed (T), quantized (Q) and entropy coded before the rate-distortion optimization decision. During the RDO, the best trade-off between data rate and distortion is determined and the respective signal selected. In the case of inter-prediction, as shown in FIG. 3, the motion vectors from the base layer MB can be used 305r,305g,305b in the enhancement layer.

An indication of the selected encoding type can be included in the syntax, e.g. in the MB type field.

FIG. 4 shows usage of an additional skip mode in each EL branch, so that RDO has 4 inputs: a new mode, so-called Skip Mode, is introduced to skip the EL residual signal. If the Skip Mode is selected through RDO, the EL contains no bits for the current MB. At the decoder, only the BL MB is decoded and the inter-layer color bit depth prediction is conducted to obtain the reconstructed EL MB. Intra-layer prediction works in principle in the same way.

The following list provides a short list of various implementations. The list is not intended to be exhaustive but merely to provide a short description of a small number of the many possible implementations.

With reference to FIG. 2 and FIG. 3, a method for encoding video data comprising base layer data and enhancement layer data, wherein the base layer and enhancement layer data comprise a plurality of color channels (such as Y, Cr, Cb or R, G, B) and wherein base layer and enhancement layer data have different bit depth, comprises steps of encoding 201y,201cr,201cb the base layer data, predicting 200 the enhancement layer data from the base layer data separately for the color channels, and encoding the enhancement layer data separately for the color channels, e.g. R, G, B, based on said predicted enhancement layer data,

wherein in at least one mode each enhancement layer color channel is predicted jointly 200 from all available base layer color channels, and the method further comprises for at least one (or some or all) of the enhancement layer color channels the further steps of
generating residual data Rᵣₑₛ,Bᵣₑₛ,Gᵣₑₛ being the difference between original enhancement layer color channel R_{EL},G_{EL},B_{EL} and predicted color channel data,
encoding 202r,202g,202b the original enhancement layer color channel data,
encoding 203r,203g,203b,204r,204g,204b the residual data, selecting RDOᵣ,RDO_{g},RDO_{b} for the at least one enhancement layer color channel either the encoded original enhancement layer color channel data, the residual data or the encoded residual data, wherein the selection is independent from the selection of other enhancement layer color channels, and
providing as enhancement layer output data the selected enhancement layer color channel data and an indication of the selected encoding mode referring to said enhancement layer color channel.

In one embodiment, the base layer and enhancement layer use different color encoding (such as Y, CR, CB and R, G, B) and the inter-layer prediction 200 further comprises color space conversion for both Intra- and Inter-coding.

In one embodiment, the color space conversion comprises conversion from YCbCr color space (Rec. BT. 709) to RGB color space (Rec. BT. 709).

In one embodiment, the encoding of the residual comprises entropy coding 204r,204g,204b.

In one embodiment, an additional encoding mode for enhancement layer color channel data comprises skip mode 405 on macro-block level: in skip mode the enhancement layer data contains no bits for the respective macro-block.

In one embodiment, in the step of selecting RDOᵣ,RDO_{g},RDO_{b} the selection is based on minimization of data rate and distortion.

In one embodiment, the prediction 200 across different color channels is done on picture level.

In one embodiment, the prediction across different color channels is done on macro-block level.

In one embodiment, the method further comprises entropy encoding EC_{Y,BL}, EC_{Cb,BL},EC_{Cr,BL},EC_{Y,EL},EC_{cb,EL},EC_{Cr,EL} separately for each base layer and enhancement layer color channel.

According to another aspect of the invention, a method for decoding encoded video data having BL data and EL data, comprises the steps of

extracting from the encoded video data the base layer data and the enhancement layer data, wherein both the base layer data and the enhancement layer comprise separate data for a plurality of color channels, extracting for at least a first color channel of the enhancement layer an indication indicating an encoding mode, decoding the base layer data of the plurality of color channels, predicting the enhancement layer data based on the decoded base layer data, wherein in at least one mode each enhancement layer color channel is predicted jointly from all available base layer color channels, decoding the enhancement layer data of the plurality of color channels, wherein residuals are obtained and wherein for at least said first color channel said indication is used for a decoding according to the indicated encoding mode, and reconstructing the enhancement layer data of the plurality of color channels based on the predicted enhancement layer data and said residuals.

The following embodiments refer to the method for decoding. In one embodiment, the base layer and enhancement layer use different color encoding (such as Y, CR, CB or R, G, B) and the step of predicting further comprises color space conversion for both Intra- and Inter-coding.

In one embodiment, the color space conversion comprises YCbCr color space to RGB color space conversion.

In one embodiment, the decoding of the residual comprises entropy decoding.

In one embodiment, an additional decoding mode for an enhancement layer color channel is employed that comprises skip mode on macro-block level, wherein in skip mode the enhancement layer data contains no bits for the respective macro-block.

In one embodiment, the prediction across different color channels is done on picture level.

In one embodiment, the prediction across different color channels is done on macro-block level.

In one embodiment, the method further comprises entropy decoding separately for each base layer and enhancement layer color channel.

According to a further aspect, an apparatus for encoding video data comprising base layer and enhancement layer, wherein the base layer and enhancement layer data comprise a plurality of color channels (such as Y, Cr, Cb or R, G, B) and wherein base layer and enhancement layer have different bit depth, comprises

means 201y,201cr,201cb for encoding the base layer, means 200 for predicting the enhancement layer from the base layer separately for the color channels, and means for encoding the enhancement layer separately for the color channels R, G, B, based on said predicted enhancement layer, wherein in at least one mode each enhancement layer color channel R, G, B is predicted jointly 200 from all available base layer color channels, and the apparatus further comprises for at least one of the enhancement layer color channels
means for generating a residual Rᵣₑₛ,Bᵣₑₛ,Gᵣₑₛ being the difference between original enhancement layer color channel R_{EL},G_{EL},B_{EL} and predicted color channel image, means 202r, 202g,202b for encoding the original enhancement layer color channel image, means 203r,203g,203b,204r,204g,204b for encoding the residual, means RDOᵣ,RDO_{g},RDO_{b} for selecting for the at least one enhancement layer color channel either the encoded original enhancement layer color channel image, the residual or the encoded residual, wherein the selection is independent from the selection of other enhancement layer color channels, and means for providing as enhancement layer output data the selected enhancement layer color channel data and an indication of the selected encoding mode referring to said enhancement layer color channel.

The following embodiments refer to the apparatus for encoding video data.

In one embodiment, the base layer and enhancement layer use different color encoding Y, CR, CB, R, G, B and the means 200 for performing inter-layer prediction further comprises means for performing color space conversion for both Intra- and Inter-coding.

In one embodiment, the color space conversion comprises YCbCr color space (Rec. BT. 709) to RGB color space (Rec. BT. 709) conversion.

In one embodiment, the means for encoding the residual comprises means 204r,204g,204b for performing entropy coding.

In one embodiment, the apparatus further comprises means 405 for performing skip mode on macro-block level as an additional encoding mode for the enhancement layer color channel, wherein in skip mode the enhancement layer contains no bits for the respective macro-block.

According to a further aspect of the invention, an apparatus for decoding encoded video data having base layer and enhancement layer data comprises means for extracting from the encoded video data the base layer data and the enhancement layer data, wherein both the base layer data and the enhancement layer comprise separate data for a plurality of color channels, means for extracting for at least a first color channel of the enhancement layer an indication indicating an encoding mode, means for decoding the base layer data of the plurality of color channels, means for predicting the enhancement layer data based on the decoded base layer data, wherein in at least one mode each enhancement layer color channel is predicted jointly from all available base layer color channels, means for decoding the enhancement layer data of the plurality of color channels, wherein residuals are obtained and wherein for at least said first color channel said indication is used for a decoding according to the indicated encoding mode, and means for reconstructing the enhancement layer data of the plurality of color channels based on the predicted enhancement layer data and said residuals.

The following embodiments refer to the apparatus for decoding encoded video data.

In one embodiment, the base layer and enhancement layer use different color encoding means for Y, CR, CB color space or R, G, B color space respectively, and the means for predicting further comprises means for performing color space conversion in both cases Intra- and Inter-coding.

In one embodiment, the means for performing color space conversion comprises means for performing YCbCr color space to RGB color space conversion.

In one embodiment, the means for decoding the residual comprises means for entropy decoding.

In one embodiment, the apparatus further comprises means for performing decoding of skip mode on macro-block level as an additional decoding mode for the at least one enhancement layer color channel, wherein in skip mode the enhancement layer data contain no bits for the respective macro-block.

In one embodiment, the means for performing the prediction across different color channels operates on picture level.

In one embodiment, the means for performing the prediction across different color channels operates on macro-block level.

In one embodiment, the apparatus further comprises means for entropy decoding separately for each base layer and enhancement layer color channel.

According to yet another aspect, an encoded video signal comprises base layer and enhancement layer data, wherein the base layer data comprise a plurality of color channels, e.g. Y, Cr, Cb, of a first color encoding and the enhancement layer data comprise a plurality of color channels, e.g. R, G, B, of a different second color encoding, wherein the base layer data and enhancement layer data have different color bit depth, and wherein the signal further comprises an encoding mode indication indicating for at least a first of the enhancement layer color channels whether it comprises either encoded residual data or, otherwise, encoded macroblock data.

According to one aspect, the joint inter-layer prediction is conducted by predicting each color channel of the enhancement layer MB from all (usually three) color channels of the reconstructed collocated base layer MB.

This disclosure describes a variety of implementations. However, features and aspects of described implementations may also be adapted for other implementations. For example, signalling may be performed using a variety of different techniques including, but not limited to, SPS syntax, other high level syntax, non-high-level syntax, out-of-band information, and implicit signalling. Further, various coding techniques may be used. Accordingly, although implementations described herein may be described in a particular context, such descriptions should in no way be taken as limiting the features and concepts to such implementations or contexts.

The implementations described herein may be implemented in, for example, a method or process, an apparatus, or a software program. Even if only discussed in the context of a single form of implementation (e.g. discussed only as a method), the implementation or features discussed may also be implemented in other forms (e.g. an apparatus or program). An apparatus may be implemented in, e.g., appropriate hardware, software, and firmware. The methods may be implemented in, e.g., an apparatus such as e.g. a computer or other processing device. Additionally, the methods may be implemented by instructions being performed by a processing device or other apparatus, and such instructions may be stored on a computer readable medium such as, for example, a CD, or other computer readable storage device, or an integrated circuit.

As should be evident to one of skill in the art, implementations may also produce a signal formatted to carry information that may be e.g. stored or transmitted. The information may include e.g. instructions for performing a method, or data produced by one of the described implementations. E.g. a signal may be formatted to carry as data the values for a particular syntax, or even the syntax instructions themselves if the syntax is being transmitted, for example. Additionally, many implementations may be implemented in either, or both, an encoder and a decoder.

Further, other implementations are contemplated by this disclosure. For example, additional implementations may be created by combining, deleting, modifying, or supplementing various features of the disclosed implementations.

It will be understood that the present invention has been described purely by way of example, and modifications of detail can be made without departing from the scope of the invention.

Each feature disclosed in the description and (where appropriate) the claims and drawings may be provided independently or in any appropriate combination. Features may, where appropriate be implemented in hardware, software, or a combination of the two. Connections may, where applicable, be implemented as wireless connections or wired, not necessarily direct or dedicated, connections. Reference numerals appearing in the claims are by way of illustration only and shall have no limiting effect on the scope of the claims.

1-15. (canceled)

16. A method for encoding video data comprising base layer data and enhancement layer data, wherein the base layer and enhancement layer data comprise a plurality of color channels and wherein base layer and enhancement layer data have different bit depth, comprising steps of
encoding the base layer data;
predicting the enhancement layer data from the base layer data separately for the color channels, wherein the base layer and enhancement layer use different color encoding and the inter-layer prediction further comprises color space conversion for Intra- and/or Inter-coding; and
encoding the enhancement layer data separately for the color channels, based on said predicted enhancement layer data;
wherein in at least one mode each enhancement layer color channel is predicted jointly from all available base layer color channels, the method further comprising for at least one of the enhancement layer color channels the further steps of
generating residual data being the difference between original enhancement layer color channel and predicted color channel data;
encoding the original enhancement layer color channel data;
encoding the residual data;
selecting for the at least one enhancement layer color channel either the encoded original enhancement layer color channel data, the residual data or the encoded residual data, wherein the selection is independent from the selection of other enhancement layer color channels; and
providing as enhancement layer output data the selected enhancement layer color channel data and an indication of the selected encoding mode referring to said enhancement layer color channel.

17. Method according to claim 16, wherein the inter-layer prediction comprises color space conversion for both Intra- and Inter-coding.

18. Method according to claim 16, wherein the color space conversion comprises YCbCr color space to RGB color space conversion and/or gamma correction.

19. Method according to claim 16, wherein an additional encoding mode for enhancement layer color channel data comprises skip mode on macro-block level, wherein in skip mode the enhancement layer data contains no bits for the respective macro-block.

20. Method according to claim 16, wherein the prediction across different color channels is done on picture level.

21. Method according to claim 16, wherein the prediction across different color channels is done on macro-block level.

22. Method according to claim 16, further comprising entropy encoding separately for each base layer and enhancement layer color channel.

23. A method for decoding encoded video data having base layer and enhancement layer data, comprising the steps of
extracting from the encoded video data the base layer data and the enhancement layer data, wherein both the base layer data and the enhancement layer comprise separate data for a plurality of color channels;
extracting for at least a first color channel of the enhancement layer an indication indicating an encoding mode;
decoding the base layer data of the plurality of color channels;
predicting the enhancement layer data based on the decoded base layer data, wherein in at least one mode each enhancement layer color channel is predicted jointly from all available base layer color channels, and wherein the base layer and enhancement layer use different color encoding and the inter-layer prediction further comprises color space conversion for Intra- and/or Inter-coding;
decoding the enhancement layer data of the plurality of color channels, wherein residuals are obtained and wherein for at least said first color channel said indication is used for a decoding according to the indicated encoding mode; and
reconstructing the enhancement layer data of the plurality of color channels based on the predicted enhancement layer data and said residuals.

24. Method according to claim 23, wherein the inter-layer prediction comprises color space conversion for both Intra- and Inter-coding.

25. Method according to claim 23, wherein the color space conversion comprises YCbCr color space to RGB color space conversion and/or gamma correction.

26. An apparatus for encoding video data comprising base layer and enhancement layer, wherein the base layer and enhancement layer data comprise a plurality of color channels and wherein base layer and enhancement layer have different bit depth, the apparatus comprising
means for encoding the base layer;
means for predicting the enhancement layer from the base layer separately for the color channels, wherein the base layer and enhancement layer use different color encoding and the means for predicting further comprises means for performing color space conversion for Intra- and/or Inter-coding; and
means for encoding the enhancement layer separately for the color channels, based on said predicted enhancement layer;
wherein in at least one mode each enhancement layer color channel is predicted jointly from all available base layer color channels, the apparatus further comprising for at least one of the enhancement layer color channels
means for generating a residual being the difference between original enhancement layer color channel and predicted color channel image;
means for encoding the original enhancement layer color channel image;
means for encoding the residual;
means for selecting for the at least one enhancement layer color channel either the encoded original enhancement layer color channel image, the residual or the encoded residual, wherein the selection is independent from the selection of other enhancement layer color channels; and
means for providing as enhancement layer output data the selected enhancement layer color channel data and an indication of the selected encoding mode referring to said enhancement layer color channel.

27. Apparatus according to claim 26, wherein the means for performing inter-layer prediction comprises means for performing color space conversion for both Intra- and Inter-coding.

28. Apparatus according to claim 26, wherein the means for performing color space conversion performs YCbCr color space to RGB color space conversion and/or gamma correction.

29. An apparatus for decoding encoded video data having base layer and enhancement layer data, comprising
means for extracting from the encoded video data the base layer data and the enhancement layer data, wherein both the base layer data and the enhancement layer comprise separate data for a plurality of color channels;
means for extracting for at least a first color channel of the enhancement layer an indication indicating an encoding mode;
means for decoding the base layer data of the plurality of color channels;
means for predicting the enhancement layer data based on the decoded base layer data, wherein in at least one mode each enhancement layer color channel is predicted jointly from all available base layer color channels, and wherein the base layer and enhancement layer use different color encoding means and the means for predicting further comprises means for performing color space conversion for Intra- and/or Inter-coding;
means for decoding the enhancement layer data of the plurality of color channels, wherein residuals are obtained and wherein for at least said first color channel said indication is used for a decoding according to the indicated encoding mode; and
means for reconstructing the enhancement layer data of the plurality of color channels based on the predicted enhancement layer data and said residuals.

30. Apparatus according to claim 29, wherein the means for predicting further comprises means for performing color space conversion for both Intra- and Inter-coding.

31. Apparatus according to claim 29, wherein the means for performing color space conversion performs YCbCr color space to RGB color space conversion and/or gamma correction.

32. An encoded video signal comprising base layer and enhancement layer data, wherein the base layer data comprise a plurality of color channels of a first color encoding and the enhancement layer data comprise a plurality of color channels of a different second color encoding, the base layer data and enhancement layer data having different color bit depth, and wherein the signal further comprises an encoding mode indication indicating for at least a first of the enhancement layer color channels whether it comprises either encoded residual data or, otherwise, encoded macroblock data.
